(19) United States
(12) Patent Application Publication
(10) Pub. No.: US 2009/0229395 A1
(43) Pub. Date: Sep. 17, 2009

(54) Structure of power transmission apparatus

(76) Inventors: Tsang-Lin Hsu, Tu-Cheng Shih (TW); Heng-I Lin, Tu-Cheng Shih (TW); Yao-Chung Tsai, Tu-Cheng Shih (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/292,355

(22) Filed: Nov. 18, 2008

(30) Foreign Application Priority Data
Mar. 14, 2008 (TW) 097204493

(51) Int. Cl. F16H 55/08

(52) U.S. Cl. 74/462

(57) ABSTRACT

An improved structure of power transmission apparatus, includes a power source supplier connected with a transmission shaft, a first driven element pivotally connected to the transmission shaft, a second driven element pivotally connected to a driven shaft and intermeshing with the first driven element, wherein both the first driven element and the second driven element are a gear being appropriately defined as a spur gear with a gear profile curve and having a pitch cone angle of a tooth, the pitch cone angle forming a first tooth curve and a second tooth curve, the pitch cone angle of the first driven element being in upside down relation to that of the second driven element to facilitate the first driven element and the second driven element being able to intermesh closely and smoothly with each other.

### BACKGROUND OF THE INVENTION

1. Field of the Invention

The present invention relates to a power transmission apparatus, and particularly to an improved structure of power transmission apparatus which has conjugate rotors closely intermeshing with each other in operation to transmit power simultaneously.

2. Related Art

As is well known, power generation is usually generated from a power source supplier and can be used to operate a certain apparatus through a transmission shaft pivotally connected to the power source supplier and the apparatus. The certain apparatus, for example, is a fan; the power is transmitted to drive the fan to blow; or the apparatus can be gears driven by the power to operate a shaft, or a roller driven for rolling, a pump driven for inletting and exhausting.

Conjugate rotors in respect of the present invention are a set of general spur gears, which have an outstanding performance in power transmission and are pivotally connected to the power source supplier through the transmission shaft. However, conventional spur gears cannot intermesh closely with each other and therefore cause a tooth backlash when shifting between clockwise rotation and anti-clockwise rotation. Furthermore, due to the spur gears continuously rotate and intermesh incompletely, the backlash may become bigger and affect stability of the power transmission and lower transmitting efficiency.

### SUMMARY OF THE INVENTION

Accordingly, an object of the present invention is to provide an improved structure of power transmission apparatus, which enables conjugate rotors of the power transmission apparatus to rotate and intermesh closely with each otherwithout producing tooth backlashes during operation.

Another object of the present invention is to provide a power transmission apparatus generating no tooth backlashes when shifting between clockwise rotation and anti-clockwise rotation of the conjugate rotors, and further ensuring a stably operation.

Still, another object of the present invention is to provide a power transmission apparatus produced at a lower cost by reducing influence of manufacturing accuracy.

To achieve the above mentioned objects, the improved structure of power transmission apparatus of the present invention includes a power source supplier connected with a transmission shaft, a first driven element pivotally connected to the transmission shaft, a second driven element pivotally connected to a driven shaft and intermeshing with the first driven element, wherein both the first driven element and the second driven element are a gear being appropriately defined as a spur gear with a gear profile curve and having a pitch cone angle of a tooth, the pitch cone angle forming a first tooth curve and a second tooth curve, the pitch cone angle of the first driven element being in upside down relation to that of the second driven element to facilitate the first driven element and the second driven element being able to intermesh closely and smoothly with each other.

The improved structure of power transmission apparatus of the present invention further includes a pressing means disposed on the transmission shaft and the driven shaft, respectively. Each of the pressing means including a resilient element and a fixing element provide an axial force to the first driven element and the second driven element to facilitate the first and the second driven elements intermesh closely with each other.

### BRIEF DESCRIPTION OF THE DRAWINGS

FIG. 1 is a plan view of an improved structure of power transmission apparatus of the present invention;

FIG. 2 is a plan view of a first driven element of a spur gear of the present invention;

FIG. 3 is a plan view of a conventional spur gear.

### DESCRIPTION OF THE PREFERRED EMBODIMENTS

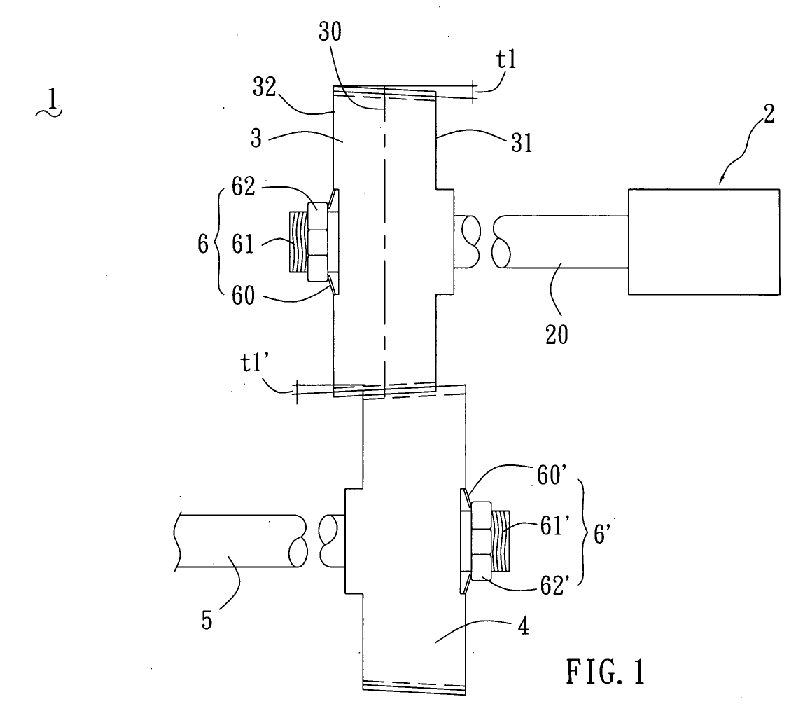

Referring to FIG. 1 illustrating a plan view of an improved structure of power transmission apparatus of the present invention, the power transmission 1 includes; a power source supplier 2, a first driven element 3, a second driven element 4, a driven shaft 5, and a pressing means 6, wherein the power source supplier 2 is connected with a transmission shaft 20. The first driven element 3 is a gear and is pivotally mounted to the transmission shaft 20. In this embodiment, the gear is defined as a spur gear with a gear profile curve 30 and a pitch cone angle t1, wherein the gear profile curve 30 is defined by taking a center line of a gear width of the spur gear, and the pitch cone angle t1 tilts from one side of the spur gear to an opposite side to form a first tooth curve 31 and a second tooth curve 32. The gear profile curve 30 and the first tooth curve 31 cooperatively defines an upper portion of the gear, while a lower portion of the gear is defined by the gear profile curve 30 and the second tooth curve 32.

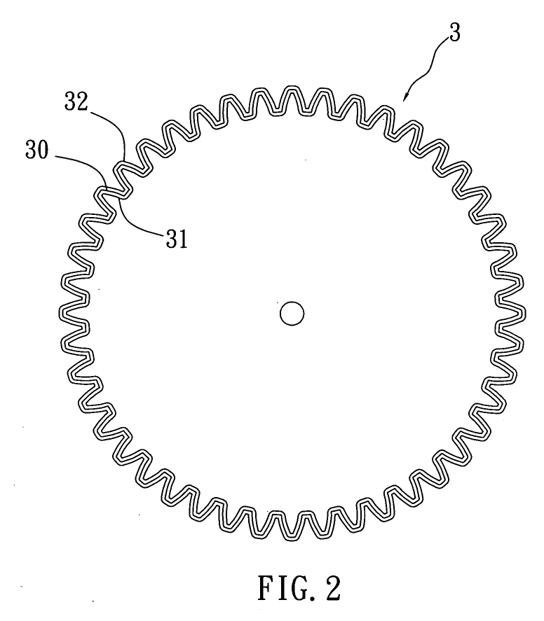

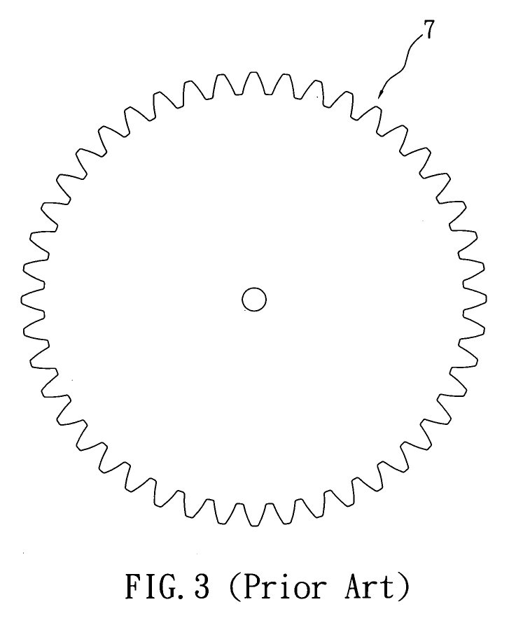

Referring to FIG. 3 illustrating a plan view of a conventional spur gear 7 and comparing with FIG. 2, obviously, the main difference between the conventional spur gear 7 and the present invention is that the conventional spur gear 7 does not define the pitch cone angle t1 on each tooth; therefore, the conventional spur gear 7 does not have the first tooth curve 31 and second tooth curve 32 of the present invention.

The pressing means 6 including a resilient element and a fixing element is mounted on the transmission shaft 20 and is in surface contact with the first driven element 3, wherein the resilient element is a compressed spring leaf 60 pivotally mounted on the transmission shaft 20 and being in surface contact with one side surface of the spur gear, and the fixing element includes screw threads 61 and a screw cap 62, the screw threads 61 formed on the transmission shaft 20 for the screw cap 62 screwing thereon to fix the compressed spring leaf 60. Accordingly, after assembly of the present invention, the compressed spring leaf 60 of the pressing means 6 provides an axial force to the first driven element 3.

The second driven element 4 intermeshing with the first driven element 3 is a spur gear and is also defined with the first tooth curve 31 and the second tooth cure 32 by a pitch cone angle t1′ (t1=t1′). The second driven element 4 is connected with the driven shaft 5 for power transmission. The difference between the first and the second driven elements 3, 4 is that the pitch cone angle t1 of the first driven element 3 is in upside down relation to the pitch cone angle t1′ of the second driven element 4. The upside down relation enables either the first driven element 3 or the second driven element 4 to rotate and intermesh closely with each other. Furthermore, the driven shaft 5 further includes a pressing means 6′ for providing an axial force to the second driven element 4. Likewise, the pressing means 6′ includes a compressed spring leaf 60′ serving as a resilient element and screw threads 61′ and screw cap 62′ both serving as a fixing element, wherein the compressed spring leaf 60′ is mounted on the driven shaft 5 in surface contact with the second driven element 4, and the screw threads 61′ formed on the driven shaft 5 for the screw cap 62′ screwing thereon to fix the compressed spring leaf 60′. Accordingly, the compressed spring leafs 60, 60′ respectively provide the axial force to the first driven element 3 and the second driven element 4, in which direction of the axial force from the compressed spring leaf 60 is opposite to that from the compressed spring leaf 60′, whereby the axial force the first driven element 3 and the second driven element 4 being able to rotate and intermesh closely with each other. In other words, after continuously operation tooth backlashes generated from the first and the second driven elements 3, 4 will be balanced by the axial force from the compressed spring leafs 60, 60′.

Consequently, through the pitch cone angles t1, t1′ and the pressing means 6, 6′, conjugate rotors can rotate and intermesh closely with each other, and the tooth backlash can be balanced, which enables the power transmission apparatus of the present invention to transmit power stably and smoothly. Therefore, because the present invention is produced simply and without serious influence of manufacturing accuracy, a manufacturing cost can be lowered.

It is understood that the invention may be embodied in other forms without departing from the spirit thereof. Thus, the present examples and embodiment are to be considered in all respects as illustrative and not restrictive, and the invention is not to be limited to the details given herein.

What is claimed is:

1. An improved structure of power transmission apparatus, comprising:
a power source supplier connected with a transmission shaft;
a first driven element pivotally mounted to the transmission shaft; and
a second driven element intermeshing with the first driven element and pivotally mounted to a driven shaft;
wherein both the first driven element and the second driven element are a gear, specifically defined as a spur gear with a gear profile curve and having a pitch cone angle, the pitch cone angle forming a first tooth curve and a second tooth curve of a tooth, the pitch cone angle of the first driven element being reserve in relation to that of the second driven element to ensure the first driven element and the second driven element intermesh closely and smoothly with each other.

2. The improved structure of power transmission apparatus as claimed in claim 1, wherein the gear profile curve of the spur gear is defined by taking a center line of the gear width or other appropriate position.

3. The improved structure of power transmission apparatus as claimed in claim 2, wherein the gear profile curve of the spur gear and the first tooth curve formed by the pitch cone angle cooperatively define an upper portion of the gear, while a lower portion of the gear is defined by the gear profile curve and the second tooth curve.

4. The improved structure of power transmission apparatus as claimed in claim 1, wherein the transmission shaft further comprises a pressing means providing an axial force to the first driven element, the pressing means including a resilient element and a fixing element.

5. The improved structure of power transmission apparatus as claimed in claim 4, wherein the driven shaft further comprises the pressing means providing an axial force to the second driven element.

6. The improved structure of power transmission apparatus as claimed in claim 5, wherein the resilient element and the fixing element are disposed respectively between the first driven element and the transmission shaft and between the second driven element and the driven shaft.

7. The improved structure of power transmission apparatus as claimed in claim 6, wherein the resilient element is a compressed leaf spring, and the fixing element includes a screw cap and screw threads formed on the transmission shaft and the driven shaft respectively.

8. The improved structure of power transmission apparatus as claimed in claim 1, wherein the first driven element and the second driven element are made of materials having different hardness.
